(19) United States
(12) Patent Application Publication
(10) Pub. No.: US 2023/0162963 A1
(43) Pub. Date: May 25, 2023

(54) EFFICIENT AND STABLE SECONDARY ION EXTRACTION APPARATUS

(71) Applicant: Institute of Geology, Chinese Academy of Geological Sciences, Beijing (CN)

(72) Inventors: Tao LONG, Beijing (CN); Chao QI, Beijing (CN); Dunyi LIU, Beijing (CN)

(21) Appl. No.: 18/055,999

(22) Filed: Nov. 16, 2022

(30) Foreign Application Priority Data
Nov. 19, 2021 (CN) 202111402511.2

(51) Int. Cl. H01J 49/06; H01J 49/24

(52) U.S. Cl. CPC H01J 49/061; H01J 49/24; H01J 49/067

(57) ABSTRACT

An efficient and stable secondary ion extraction apparatus for ion mass spectrometry has a sample target, a primary ion optical unit, a secondary ion extraction unit, an electronic gun, an ion lens and an ion deflection unit. The primary ion optical unit generates primary ions. The secondary ion extraction unit extracts secondary ions generated by the sample target. The electronic gun neutralizes charges accumulated on the surface of a sample. The ion lens focuses the secondary ions from the secondary ion extraction unit. The ion deflection unit carries out low-aberration deflection on the focused secondary ions. An extraction electrode consisting includes the surface of the sample target, a first extraction electrode and a second extraction electrode that extracts the secondary ions. When charges are accumulated on the surface of the sample target by the primary ions, the charges on the surface of the sample target are neutralized using the electronic gun.

### FIELD

The present disclosure relates to the technical field of ion mass spectrometry, in particular to an efficient and stable secondary ion extraction apparatus.

### BACKGROUND

Secondary ion mass spectrometry is a very sensitive surface analysis instrument, secondary ions are generated on the surface of a sample by sputtering primary ions with different energies on the surface of the sample, and the ions enter a mass analysis instrument through a secondary ion extraction system, so that surface substance analysis is realized. The analysis sensitivity can reach sub-ppm level, but the efficiency of generating secondary ions by sputtering a sample with primary ions is very low, and the key for realizing high sensitivity, high stability and high precision of an instrument is to realize high-efficiency and stable extraction of the secondary ions.

In practice, on one hand, the surface of a sample is difficult to be completely flat, and then analysis precision may be affected; and on the other hand, an immersion lens in an extraction lens adsorbs the sample, and after long-time adsorption and accumulation, the adsorbed sample falls onto the surface of a sample again, so that a wrong analysis result is generated.

### SUMMARY

The present disclosure aims to overcome at least one of the defects in the prior art, and provides an efficient and stable secondary ion extraction apparatus, which can reduce influence of surface roughness of a sample on an analysis result, and can relieve adsorption of the sample on the tip of a traditional extraction electrode, thereby realizing stable and efficient extraction of ions and ensuring the reliability of data.

The present disclosure utilizes the following technical solutions:
an efficient and stable secondary ion extraction apparatus comprises a sample target, a primary ion optical unit, a secondary ion extraction unit, an electronic gun, an ion lens and an ion deflection unit; the primary ion optical unit is used for generating primary ions, and the primary ions are sputtered to the sample target to generate secondary ions;
the secondary ion extraction unit is used for extracting the secondary ions generated by the sample target;
the electronic gun is used for neutralizing charges accumulated on the surface of a sample when secondary positive ions are analyzed;
the ion lens is used for focusing the secondary ions from the secondary ion extraction unit; and the ion deflection unit is used for carrying out low-aberration deflection on the focused secondary ions.

In any one of the above possible implementation manners, further provided is an implementation manner that a sample is adhered to the sample target, and the surface layer of the sample target is plated with gold for electric conduction.

In any one of the above possible implementation manners, further provided is an implementation manner that the secondary ion extraction unit comprises a first extraction electrode and a second extraction electrode; and
the sample target, the first extraction electrode and the second extraction electrode are successively arranged; an extraction lens is formed on the first extraction electrode, the second extraction electrode and the surface of the sample to extract the secondary ions; the first extraction electrode is parallel to the sample target, the first extraction electrode applies low voltage, a uniform weak electric field is formed between the first extraction electrode and the sample target, and a small hole for the secondary ions to pass through is formed in the middle of the first extraction electrode; and
the second electrode applies high voltage, and an immersion lens is formed on the second electrode and the surface of the sample to provide voltage difference for secondary ion extraction.

In any one of the above possible implementation manners, further provided is an implementation manner that the primary ion optical unit comprises an ion source, a lens, a deflection plate and micropores which are arranged successively; and the ion source generates primary ions, the primary ions are positive ions or negative ions, and focusing of which is realized by passing through the lens, the deflection plate and the micropores successively, and the primary ions are sputtered to the sample on the sample target to generate secondary ions.

In any one of the above possible implementation manners, further provided is an implementation manner that one surface of the first extraction electrode is a flat plate while the other surface is an annular protrusion; and the flat plate surface corresponds to the sample target, an oblique plane formed by the annular protrusion is parallel to the top surface of the electronic gun and the top surface of the ion source, a duct is formed in the annular protrusion, and electrons emitted by the electronic gun and the primary ions generated by the ion source reach the sample on the sample target through the duct.

In any one of the above possible implementation manners, further provided is an implementation manner that the ion deflection unit comprises a first double-end bipolar deflection plate and a second double-end bipolar deflection plate, the first double-end bipolar deflection plate and the second double-end bipolar deflection plate have the same structure and both are two sets of symmetric deflection plates, and voltage applied by each set of deflection plates is double-end bipolar voltage;
the ion lens is arranged between the first double-end bipolar deflection plate and the second double-end bipolar deflection plate; and
the secondary ions extracted by the secondary ion extraction unit generally have a certain angle, the secondary ions are subjected to angle correction after passing through the first double-end bipolar deflection plate, thus, the secondary ions approach the position of the axis of the ion lens, ion divergence is relieved, then the secondary ions enter the ion lens to achieve focusing of the secondary ions, the secondary ion transmission efficiency is improved, the direction of the secondary ions is changed after the secondary ions pass through the second double-end bipolar deflection plate, and then the secondary ions enter a follow-up analysis instrument.

In any one of the above possible implementation manners, further provided is an implementation manner that the ion lens is a single lens, the single lens comprises three electrodes and two isolating parts, the electrodes and the isolating parts are superposed successively, the potentials of the electrodes at two ends are the same, the potential of the electrode in the middle is different, and focusing of the secondary ions is realized by changing the voltage of the electrodes at the two ends and the voltage of the electrode in the middle.

In any one of the above possible implementation manners, further provided is an implementation manner that the ion lens is a lens group.

In any one of the above possible implementation manners, further provided is an implementation manner that central axes of the sample target, the first extraction electrode, the second extraction electrode, the first double-end bipolar deflection plate, the second double-end bipolar deflection plate and the ion lens are superposed.

In any one of the above possible implementation manners, further provided is an implementation manner that the voltage of the sample target provides energy voltage for the secondary ions, the difference between the voltage of the first extraction electrode and the voltage of the sample target is smaller than 10% of the voltage of the sample target, and the voltage of the second extraction electrode is determined according to the distances among the sample target, the first extraction electrode and the second extraction electrode.

In any one of the above possible implementation manners, further provided is an implementation manner that the primary ions are positive ions or negative ions.

In any one of the above possible implementation manners, further provided is an implementation manner that the apparatus is in a vacuum environment.

The present disclosure has the beneficial effects that:

1. Efficient and stable extraction of the secondary ions is realized by the secondary ion extraction system.

2. The secondary ions are extracted by the gold-plated surface of the sample, the first extraction electrode and the second extraction electrode, and a weak uniform electric field is formed between the gold-plated surface of the sample and the first extraction electrode. The weak electric field can reduce influence on analysis precision of stable isotopes due to the uneven surface of the sample, thereby improving the analysis precision of the stable isotopes. The uniform electric field can reduce the position effect of the stable isotopes of samples at different positions on the analysis sample target, thereby improving the analysis precision of the stable isotopes.

3. The sample target approaches the second extraction electrode to increase the extraction receiving angle of the secondary ions, and thus, the secondary ion extraction efficiency is improved.

4. The first double-end bipolar deflection system, the single lens and the second double-end bipolar deflection system form an efficient secondary ion transmission system, thus, the transmission efficiency of an instrument is improved, and high sensitivity of the instrument is realized.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a structure diagram of an efficient and stable secondary ion extraction apparatus according to an embodiment of the present disclosure.

FIG. 2 is an effect diagram of electric field distribution of the secondary ion extraction system in an embodiment.

FIG. 3 is a simulated diagram of a uniform electric field of the surface of a sample target in an embodiment.

FIG. 4 is an effect diagram of secondary ion extraction in an embodiment.

In the figures, 1-sample target; 2-1-first extraction electrode; 2-2-second extraction electrode; 3-primary ion optical unit; 4-electronic gun; 5-first double-end bipolar deflection plate; 6-ion lens; and 7-second double-end bipolar deflection plate.

### DETAILED DESCRIPTION OF THE EMBODIMENTS

Specific embodiments of the present disclosure will be described in detail below with reference to the specific drawings. It should be noted that technical features or combinations of technical features described in the following embodiments should not be considered in isolation, and they may be combined with each other to achieve better technical effects. In the drawings of the embodiments described below, the same reference numerals appearing in the various drawings denote the same features or components, and may be applied to different embodiments.

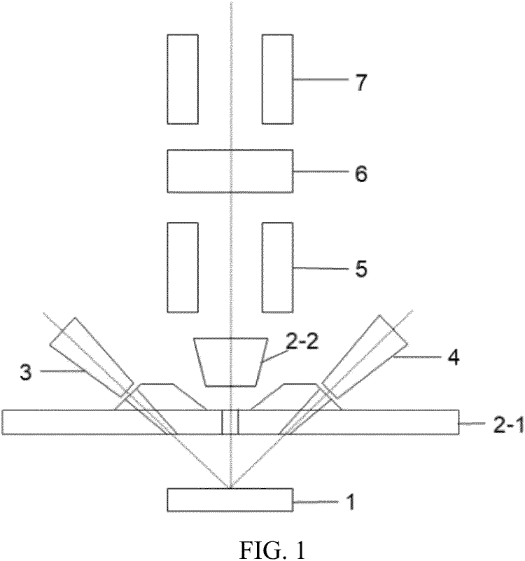

As shown in FIG. 1, provided in an embodiment of the present disclosure is an efficient and stable secondary ion extraction apparatus, the apparatus is in a vacuum environment, the apparatus comprises a sample target 1, a primary ion optical unit 3, a secondary ion extraction unit, an electronic gun 4, an ion lens 6 and an ion deflection unit;
the primary ion optical unit 3 is used for generating primary ions, and the primary ions are sputtered to the sample target 1 to generate secondary ions;
the secondary ion extraction unit is used for extracting secondary ions generated by the sample target 1;
the electronic gun 4 is used for neutralizing charges accumulated on the surface of the sample while secondary positive ions are analyzed;
the ion lens 6 is used for focusing the secondary ions from the secondary ion extraction unit; and the ion deflection unit is used for carrying out low-aberration deflection on the focused secondary ions.

In a particular embodiment, a sample is adhered to the sample target 1, the surface layer of the sample target 1 is plated with gold for electrical conduction, and the sample target 1 provides a high voltage of energy of secondary ions which may be positive or negative, wherein the high voltage is applied in a range from negative tens of thousands of volts to positive tens of thousands of volts, for example, -20000 to +20000 volts.

In a particular embodiment, the secondary ion extraction unit comprises a sample target 1, a first extraction electrode 2-1 and a second extraction electrode 2-2; the sample target 1, the first extraction electrode 2-1 and the second extraction electrode 2-2 are successively arranged; the first extraction electrode 2-1, the second extraction electrode 2-2 and the surface of a sample form an extraction lens to extract secondary ions; the first extraction electrode 2-1 is parallel to the sample target 1, the first extraction electrode 2-1 applies low voltage to form a uniform weak electric field between the first extraction electrode 2-1 and the sample target 1, and a small hole for the secondary ions to pass through is formed in the middle of the first extraction electrode 2-1; thus, influence of surface roughness of the sample to an analysis result is reduced, and besides, adsorption of the sample at the tip of the extraction electrode can be relieved; and the second extraction electrode 2-2 applies high voltage, an immersion lens is formed by the second extraction electrode 2-2 and the surface of the sample, and voltage difference is provided for secondary ion extraction; and therefore, stable and efficient extraction of ions is realized, and reliability of data is guaranteed.

In a particular embodiment, the primary ion optical unit 3 comprises an ion source, a lens, a deflection plate and micropores; the ion source generates primary ions, the primary ions may be positive ions or negative ions, focusing of the primary ions is realized through the lens, the deflection plate and the micropores to form a primary ion beam, and the primary ion beam is sputtered to a sample on the sample target 1 to generate secondary ions.

In a particular embodiment, one surface of the first extraction electrode 2-1 is a flat plate while the other surface is an annular protrusion; the flat plate surface corresponds to the sample target 1, and the annular protrusion surface corresponds to the second extraction electrode 2-2; and an oblique plane formed by the annular protrusion is parallel to the top surfaces (conical top surfaces) of the electronic gun 4 and the ion source, a duct is formed in the annular protrusion, and electrons emitted by the electronic gun 4 and the primary ions generated by the ion source reach the sample on the sample target 1 through the duct. In a preferred embodiment, the electronic gun 4 and the ion source are symmetrically arranged on two sides of the sample target 1.

In a particular embodiment, the ion deflection unit comprises a first double-end bipolar deflection plate 5 and a second double-end bipolar deflection plate 7, the first double-end bipolar deflection plate 5 and the second double-end bipolar deflection plate 7 have the same structure and are two sets of symmetric deflection plates, and voltage applied by each set of deflection plates is double-end bipolar voltage; the ion lens 6 is arranged between the first double-end bipolar deflection plate 5 and the second double-end bipolar deflection plate 7; and secondary ions extracted by the secondary ion extraction unit generally have a certain angle (an included angle between the movement direction of the ions and the axis of the apparatus), the secondary ions are subjected to angle correction after passing through the first double-end bipolar deflection plate 5, thus, the secondary ions approach the position of the axis of the ion lens 6, ion divergence is relieved, then the secondary ions enter the ion lens 6 to realize focusing of the secondary ions, the secondary ion transmission efficiency is improved, after the secondary ions pass through the second double-end bipolar deflection plate 7, the direction of the secondary ions is changed, and the secondary ions efficiently enter the follow-up analysis instrument.

In a particular embodiment, the ion lens 6 is a single lens, the single lens comprises three electrodes and two isolating parts, the electrodes and the isolating parts are successively superposed together, wherein the potentials of the electrodes at two ends are the same, the potential of the electrode in the middle is different, and focusing of the secondary ions is realized by changing the voltage of the electrodes at the two ends and the voltage of the electrode in the middle.

In another particular embodiment, the ion lens 6 is a lens group.

Central axes of the sample target 1, the first extraction electrode 2-1, the second extraction electrode 2-2, the first double-end bipolar deflection plate 5, the second double-end bipolar deflection plate 7 and the ion lens 6 are superposed.

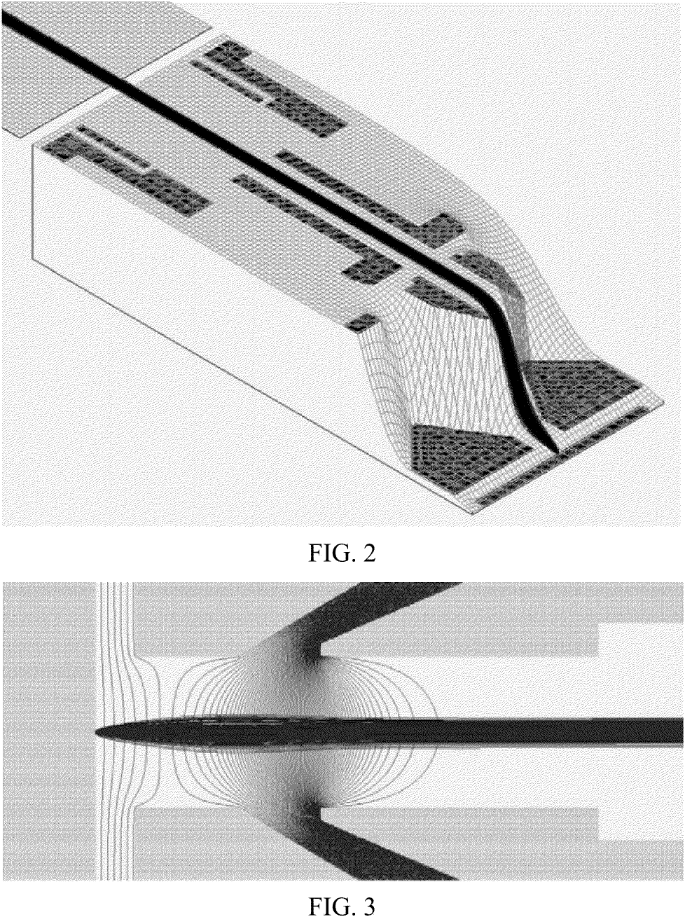

FIG. 2 is an effect diagram of electric field distribution of the secondary ion extraction system. Various electrodes correspond to electrodes in FIG. 1, it can be seen from FIG. 2 that an electric field between the surface of the sample target 1 and the first extraction electrode 2-1 is much lower than an electric field between the first extraction electrode 2-1 and the second extraction electrode 2-2, the electric field between the sample target 1 and the first extraction electrode 2-1 is smaller, thus, influence of the surface roughness of the sample target 1 to uniformity of the electric field is reduced, and fractionation of an instrument is reduced.

FIG. 3 is a simulated diagram of a uniform electric field of the surface of the sample target 1. It can be seen from FIG. 3 that electric field lines between the sample target 1 and the first extraction electrode 2-1 are basically parallel, the electric field intensity between the sample target and the first extraction electrode is lower than the electric field intensity between the first extraction electrode 2-1 and the second extraction electrode 2-2, under the condition of a small and uniform magnetic field, distribution of the electric field lines is hardly affected even if the surface of the sample has tiny shape change, thus, stable extraction of the secondary ions can be realized, and the analysis precision of stable isotopes is improved.

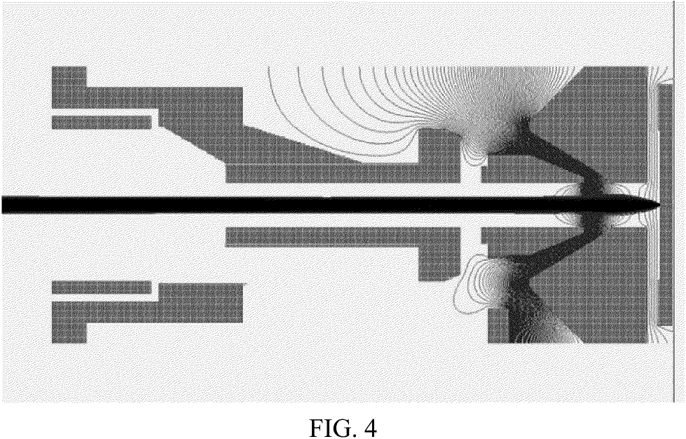

FIG. 4 is an effect diagram of secondary ion extraction in a particular embodiment. Parallel and efficient extraction of the secondary ions is realized by the secondary ion extraction apparatus consisting of the sample target 1, the first extraction electrode 2-1, the second extraction electrode 2-2, the first double-end bipolar deflection plate 5, the ion lens 6 and the second double-end bipolar deflection plate 7, thus, the secondary ion transmission efficiency can be improved, and influence of the surface roughness of the sample to the analysis precision can be reduced.

The present disclosure has the following working principles:

primary ions with different energy are bombarded to the sample adhered to the sample target 1, the secondary ions are generated by sputtering, and efficient and stable extraction of the secondary ions is realized by the extraction electrode formed by the surface of the sample target 1, the first extraction electrode 2-1 and the second extraction electrode 2-2. When charges are accumulated on the surface of the sample target 1 by the primary ions, the charges on the surface of the sample target are neutralized by utilizing the electronic gun 4. Low-aberration and high-efficiency transmission of ions is realized by the transmission system consisting of the first double-end bipolar deflection system, the second double-end bipolar deflection system and the single lens.

While several embodiments of the present disclosure have been presented herein, it will be appreciated by those skilled in the art that changes may be made to the embodiments described herein without departing from the spirit of the present disclosure. The above embodiments are merely illustrative and should not be taken as limiting the scope of the claims of the present disclosure.

1. An efficient and stable secondary ion extraction apparatus, wherein, comprising a sample target, a primary ion optical unit, a secondary ion extraction unit, an electronic gun, an ion lens and an ion deflection unit; wherein
the primary ion optical unit is used for generating primary ions, and the primary ions being sputtered to the sample target to generate secondary ions;
the secondary ion extraction unit is used for extracting the secondary ions generated by the sample target;
the electronic gun is used for neutralizing charges accumulated on the surface of a sample;
the ion lens is used for focusing the secondary ions from the secondary ion extraction unit; and
the ion deflection unit is used for carrying out low-aberration deflection on the focused secondary ions.

2. The efficient and stable secondary ion extraction apparatus according to claim 1, wherein the sample is adhered to the sample target, and the surface layer of the sample target is plated with gold.

3. The efficient and stable secondary ion extraction apparatus according to claim 1, wherein the secondary ion extraction unit comprises a first extraction electrode and a second extraction electrode; and
the sample target, the first extraction electrode and the second extraction electrode are successively arranged; the first extraction electrode is parallel to the sample target, the first extraction electrode applies low voltage to form a uniform weak electric field between the first extraction electrode and the sample target, and a small hole for the secondary ions to pass through is formed in the middle of the first extraction electrode; and the secondary electrode applies high voltage, and an immersion lens is formed by the secondary electrode and the surface of the sample to provide voltage difference for secondary ion extraction.

4. The efficient and stable secondary ion extraction apparatus according to claim 1, wherein the primary ion optical unit comprises an ion source, a lens, a deflection plate and micropores which are arranged successively; and the ion source generates primary ions, the primary ions are positive ions or negative ions, and focusing of which is realized by passing through the lens, the deflection plate and the micropores successively; the primary ions are sputtered to the sample on the sample target to generate secondary ions.

5. The efficient and stable secondary ion extraction apparatus according to claim 4, wherein one surface of the first extraction electrode is a flat plate while the other surface is an annular protrusion; and the flat plate surface corresponds to the sample target, an oblique plane formed by the annular protrusion is parallel to the top surfaces of the electronic gun and the ion source, a duct is formed in the annular protrusion, and electrons emitted by the electronic gun and the primary ions generated by the ion source reach the sample on the sample target through the duct.

6. The efficient and stable secondary ion extraction apparatus according to claim 1, wherein the ion deflection unit comprises a first double-end bipolar deflection plate and a second double-end bipolar deflection plate, the first double-end bipolar deflection plate and the second double-end bipolar deflection plate have the same structure, and both are two sets of deflection plates in symmetric arrangement, and voltage applied by each set of deflection plates is double-end bipolar voltage;
the ion lens is arranged between the first double-end bipolar deflection plate and the second double-end bipolar deflection plate; and
the secondary ions extracted by the secondary ion extraction unit are subjected to angle correction after passing through the first double-end bipolar deflection plate, and then enter the ion lens to be focused, after the secondary ions pass through the secondary double-end bipolar deflection plate, the direction of the secondary ions is changed, and then the secondary ions enter a follow-up analysis instrument.

7. The efficient and stable secondary ion extraction apparatus according to claim 1, wherein the ion lens is a single lens, and it comprises three electrodes and two isolating parts; the electrodes and the isolating parts are successively superposed together, the potentials of the electrodes at two ends are the same, the potential of the electrode in the middle is different, and focusing of the secondary ions is realized by changing the voltage of the electrodes at the two ends and the voltage of the electrode in the middle.

8. The efficient and stable secondary ion extraction apparatus according to claim 6, wherein central axes of the sample target, the first extraction electrode, the second extraction electrode, the first double-end bipolar deflection plate, the second double-end bipolar deflection plate and the ion lens are superposed.

9. The efficient and stable secondary ion extraction apparatus according to claim 1, wherein the voltage of the sample target provides energy voltage for the secondary ions, the difference between the voltage of the first extraction electrode and that of the sample target is smaller than 10% of the voltage of the sample target, and the voltage of the second extraction electrode is determined according to distances among the sample target, the first extraction electrode and the second extraction electrode.

10. The efficient and stable secondary ion extraction apparatus according to claim 1, wherein the secondary ion extraction apparatus is in a vacuum environment.
